(19) United States
(12) Patent Application Publication
(10) Pub. No.: US 2022/0376975 A1
(43) Pub. Date: Nov. 24, 2022

(54) SYSTEMS AND METHODS FOR MODEM CONFIGURATION AND ROLLBACK

(71) Applicant: ARRIS Enterprises LLC, Suwanee, GA (US)

(72) Inventors: Xinhua CHEN, Shenzhen, Guangdong (CN); Shengbin ZHU, Shenzhen, Guangdong (CN); Bo CHEN, Shenzhen, Guangdong (CN); Shixi ZOU, Shenzhen, Guangdong (CN)

(73) Assignee: ARRIS Enterprises LLC, Suwanee, GA (US)

(21) Appl. No.: 17/268,575

(22) PCT Filed: Feb. 14, 2020
(86) PCT No.: PCT/CN2020/075325

§ 371 Date: Feb. 15, 2021

(51) Int. Cl. H04L 41/0816; H04L 41/0853

(52) U.S. Cl. CPC H04L 41/0816; H04L 41/0856

(57) ABSTRACT

Embodiments relate to creating a backup configuration page for a modem. The backup configuration page can be accessed while the modem is experiencing a service problem to facilitate restoring the configuration settings of the modem to those associated with the backup configuration page. In some embodiments, a configuration diagnostic test can be performed before saving the configuration settings as the backup configuration page so as to assure a user that the configuration settings of the backup configuration page do not or will not create a service problem.

### TECHNICAL FIELD

Embodiments relate to systems and methods for creating a backup configuration page for a modem.

### BACKGROUND

A modem is a device that converts data into a format suitable for a certain transmission medium, facilitating data transmission to and from separate communication devices. A modem operates by modulating one or more carrier wave signals to encode digital information from a transmitting communication device for transmission of the encoded carrier wave signal through a transmission medium. A second modem associated with a receiving communication device demodulates the encoded carrier wave signal to decode the digital information for use by the receiving communication device. Typically, modems are used in communication systems in which a first communication device is configured to communicate with a second communication device, where each communication device generates and receives digital information but that digital information is more efficiently transmitted via an analog signal. Conversion of the digital information to and from the carrier wave is done so that the digital information can be transmitted efficiency through the transmission medium and decoded in a reliable manner, thereby facilitating reproduction of the original digital information.

Modems can function as gateways (e.g., network nodes equipped to interface a communication device operating on a first communication protocol with a communication device operating on a second communication protocol). An example of a communication protocol can be an Internet protocol suite, which typically includes the Transmission Control Protocol and the Internet Protocol (TCP/IP). Because a modem can operate as a gateway, it may be beneficial to configure the modem to implement specific, personalized communication protocols and security features when operating. This may be done to provide more tailored operational control for the information being received and transmitted via user's communication device to which the modem is operatively associated.

In an exemplary communication architecture, the first communication device (e.g., a computer) will be connected to a first modem, the second communication device (e.g. a computer) will be connected to a second modem, and the first modem and second modem will be configured to transmit and receive signals to and from each other via a transmission medium (e.g., electrical wire, telephone line, co-axial cable, optical fiber, etc.). The first communication device can generate digital information and the first modem can modulate the digital information to encode it into a carrier wave. The first modem can transmit the carrier wave to the second modem, where the second modem demodulates the carrier wave to reproduce the digital information, which is then transmitted to the second communication device. The communication protocol facilitating the transmission of signals between the two communication devices will be TCP/IP. Any of the first and/or second modems' Internet communication protocols and security features can be configured to allow a user of the first communication device or a user of the second communication device to set operational and security parameters by which their respective communication devices will receive and/or transmit information to the other communication device, allow or prevent other first or second communication devices to join the communications network, set validation protocols for security measures, etc. These specific configurations are referred to as configuration pages, and when the modems are used for Internet communications these configuration pages are sometimes embodied as Web Graphical User Interfaces (WebGUIs). A modem can have a processor operatively associated with a memory, the processor being configured to run on software (e.g., an operating system). This software is typically stored in the memory. The configuration pages are also stored in the memory. When the modem is operated, the software can cause the processor to acquisition the information embodied in the configuration pages from the memory and operate the modem within the operational parameters set by the configuration pages.

Again, because a modem can operate as a gateway, additional security measures (security measures in addition to the security features discussed above) designed to prevent execution of the modem's functions can be in place to prevent data transmission to and from the communication device to which it is connected until assurances (e.g., validations) are satisfied. A malfunction, an operational mode failure, a detected security anomaly, corrupted software or firmware, etc. can lead to one of these security measures preventing a modem from executing a function, thereby preventing operation (or at least proper operation) of the modem. A modem being prevented from operating, or operating properly, is referred to herein as experiencing a service problem. In some cases, a user's configuration settings (e.g., the configuration pages) for the modem can trigger a service problem. When a modem experiences a service problem, a user then has to perform diagnostic analyses to determine what led to the service problem and how to correct it. Unfortunately, with regards to the configuration settings, a user's only recourse in these situations is to reset the Internet communication protocols and security features to their default settings. This poses at least three problems: 1) a user does not have access to the once-saved configuration pages to assist them with re-configuring the modem after performing a reset (i.e., a user is left to blindly guess how to arrange the configuration pages); 2) even if a user did record the configuration pages on another device for example, they then would have to spend the time navigating the modem settings and re-configuring them in accordance with their desired configuration pages; and 3) a user cannot determine if it was a specific Internet communication protocol configuration and/or security feature configuration of their own configuration page that led to the service problem (i.e., implementing the same settings may cause the modem to once again experience the same service problem).

### SUMMARY

The systems and methods disclosed herein relate to creating a backup configuration page for a modem. The backup configuration page can be accessed while the modem is experiencing a service problem to facilitate restoring the configuration settings of the modem to those associated with the backup configuration page. In some embodiments, a configuration diagnostic test can be performed before saving the configuration settings as the backup configuration page so as to assure a user that the configuration settings of the backup configuration page do not or will not create a service problem.

In one embodiment, a modem can include a processor having a configurations page driver. The modem can further include a memory operatively associated with the processor. The configurations page driver can be configured to store configuration settings of the modem as a backup configuration page in the memory.

In some embodiments, the configuration page driver is configured to access the configuration settings of the backup configuration page and cause the processor to operate the modem in accordance with an operating parameter set by the configuration settings.

In some embodiments, the memory includes default configuration settings. The configuration settings of the backup configuration page include modifications made to the default configuration settings.

In some embodiments, the modem includes a Unified Extensible Firmware Interface (UEFI) driver, the UEFI driver being configured to provide a software interface between an operating system for the modem and firmware for the modem. The configuration page driver is configured to run from the UEFI driver.

In some embodiments, the configuration page driver is configured to perform a diagnostic test.

In some embodiments, the diagnostic test includes a voice service diagnostic test, a Data Over Cable Service Interface Specification (DOCSIS) service test, and/or a Wireless Fidelity (Wi-Fi) service test.

In some embodiments, the diagnostic test is configured to generate a negative result if the diagnostic test indicates a service problem with the modem. The diagnostic test is configured to generate a positive result if the diagnostic test indicates no service problem with the modem.

In some embodiments, the configurations page driver is configured to store configuration settings of the modem as the backup configuration page in the memory after the diagnostic test is performed.

In some embodiments, the configurations page driver is configured to store the configuration settings of the modem as the backup configuration page in the memory when the diagnostic test generates the positive result.

In some embodiments, the configurations page driver is configured to prevent storage of the configuration settings of the modem as the backup configuration page in the memory when the diagnostic test generates the negative result.

In some embodiments, the configurations page driver is configured to cause the processor to generate a warning signal when the diagnostic test generates the negative result.

In some embodiments, the warning signal is displayed as part of a Web Graphical User Interface (WebGUI). In addition, or in the alternative, the warning signal is transmitted to the processor to cause the processor to illuminate at least one light indicator of the modem in an illumination sequence and/or illumination scheme.

In some embodiments, the diagnostic test involves analytics to determine whether the configuration settings lead to a service problem for the modem. The configurations page driver is configured to cause the processor to generate a warning signal when the diagnostic test determines that the configuration settings lead to the service problem.

In some embodiments, the warning signal includes information about the configuration settings that led to the service problem.

In some embodiments, the warning signal is displayed as part of a Web Graphical User Interface (WebGUI). In addition, or in the alternative, the warning signal is transmitted to the processor to cause the processor to illuminate at least one light indicator of the modem in an illumination sequence and/or illumination scheme.

In one embodiment, a communication system can include: a first communication device in connection with a first modem, and a second communication device in connection with a second modem. The first modem can include a first processor having a first configurations page driver, and a first memory operatively associated with the first processor. The first configurations page driver is configured to store configuration settings of the first modem as a first backup configuration page in the first memory.

In some embodiments, the second modem can include a second processor having a second configurations page driver; a second memory operatively associated with the second processor. The second configurations page driver is configured to store configuration settings of the second modem as a second backup configuration page in the second memory.

In one embodiment, a method for creating a backup configuration page for a modem can involve storing configuration settings of a modem as a backup configuration page in a memory of the modem, the configuration settings being different from default configuration settings for the modem.

In some embodiments, the method further involves accessing the configuration settings of the backup configuration page to set an operating parameter of the modem.

In some embodiments, storing the configuration settings involves generating the backup configuration page each time the configuration settings are modified, generating the backup configuration page periodically, and/or generating the backup configuration page on-demand.

### BRIEF DESCRIPTION OF THE DRAWINGS

FIG. 1 is an exemplary block diagram showing component parts of an embodiment of the modem.

FIG. 2 is an exemplary communication system in which an embodiment of the modem can be used.

FIG. 3 shows an exemplary hardware architecture for an embodiment of a communication device.

### DETAILED DESCRIPTION

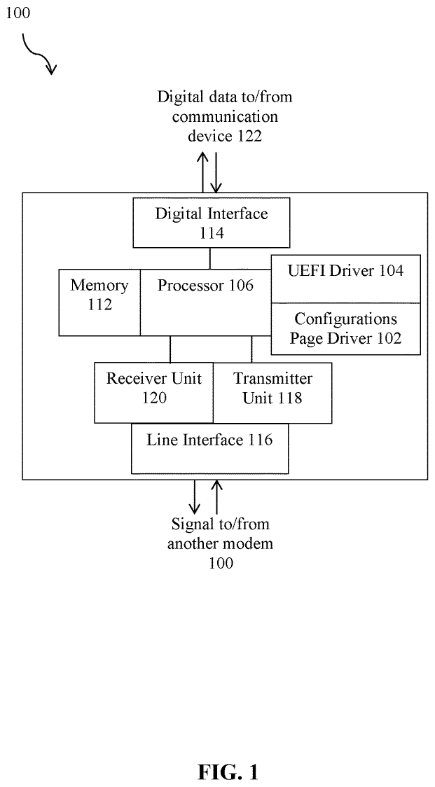

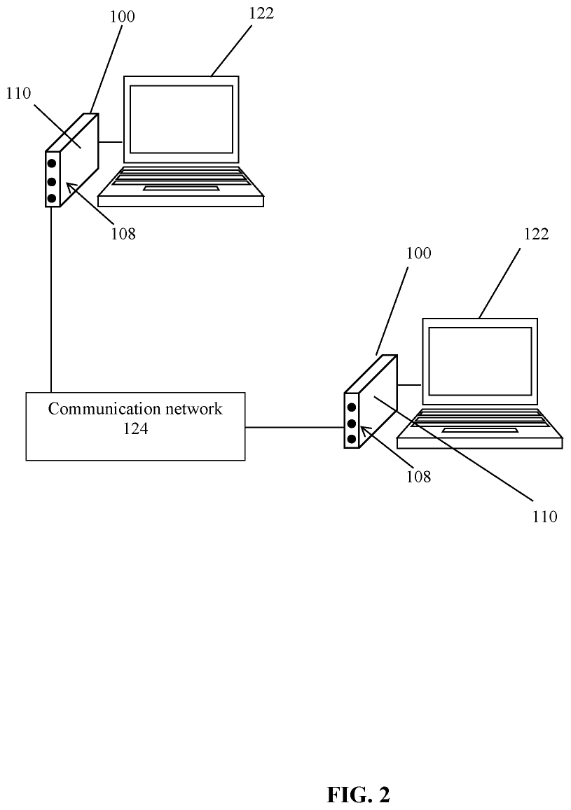

Referring to FIGS. 1-2, embodiments of the systems and methods disclosed herein are related to creating a backup configuration page for a modem 100. The backup configuration page can be accessed while the modem 100 is experiencing a service problem to facilitate restoring the configuration settings of the modem 100 to those associated with the backup configuration page. In some embodiments, the backup configuration page can be accessed after the modem 100 has experienced a service problem to facilitate restoring the configuration settings of the modem 100 to those associated with the backup configuration page. For instance, if a modem's 100 configuration settings have to be reset to its default settings, the backup configuration page can be accessed to either use the backup configuration page as the default settings or be used to restore the configuration settings to the backup configuration page after the modem's 100 configuration settings have to be reset to its default settings. In some embodiments, the systems and methods disclosed herein perform a configuration diagnostic test before saving the configuration settings as the backup configuration page so as to assure a user that the configuration settings of the backup configuration page do not or will not create a service problem.

The modem 100 can have a housing 110 configured to contain operating modules for the modem 100. These operating modules can include a processor 106 in operative association with a memory 112, a digital interface 114, a line interface 116, a transmitter unit 118, and a receiver unit 120. The processor 106 can be configured to execute software (e.g., operating system software) and firmware stored on the memory 112. The processor 106 can be a central processing unit (CPU), for example. The memory 112 can include volatile memories and non-volatile memories. The non-volatile memories can include a Not Or (NOR) flash memory, a Not And (NAND) flash memory, and a Non-Volatile Random Access Memory (NVRAM) memory. The digital interface 114 can include integrated circuitry configured to receive and transmit digital data to and from a communication device 122. The processor 106 can receive the digital data from the digital interface 114 and encode the data. The transmitter unit 118 can include integrated circuitry configured to generate a carrier signal, receive the encoded data from the processor 106, and modulate the carrier signal with the encoded data. The transmitter unit 118 can transmit the modulated carrier signal to the line interface 116. The line interface 116 can include integrated circuitry configured to transmit the modulated carrier signal to a transmission medium (e.g., electrical wire, telephone line, co-axial cable, optical fiber, etc.).

The modulated carrier signal may travel though at least one communication network 124 to another modem 100. For instance, a first communication device 122 can be connected to a first modem 100. A second communication device 122 can be connected to a second modem 100. The first modem 100 and the second modem 100 can be configured to transmit and receive signals to and from each other via at least one communication network 124. In an exemplary implementation, the first modem 100 can be the transmitting modem 100 and operate to generate the modulated carrier signal described above. The second modem 100 can be the receiving modem 100 configured to receive the modulated carrier signal. The receiving modem 100 can receive the modulated carrier signal via its line interface 116. The receiver unit 120 (having integrated circuitry configured to demodulate the carrier signal) of the receiving modem 100 can demodulate the carrier signal and extract the encoded digital data. The encoded digital data can be transmitted to the receiving modem's processor 106 where the original digital data is reproduced. The original digital data is then transmitted to the receiving modem's digital interface 114, where the original digital data is transmitted to the second communication device 122.

The digital interface 114 and/or the line interface 116 can also include ports, couplings, and/or connectors (any of which may include data communication equipment (DCE) or data terminal equipment (DTE)) to facilitate electrical and/or optical connection to a communication device 122 via telephone lines, Transmission System-1 (T1) lines, Integrated Services Digital Network (ISDN) lines, etc.

In some embodiments, the processor 106 can include a configurations page driver 102. The configurations page driver 102 can be a software module or engine configured to define a software interface between the modem's 100 operating system and its memory 112. Embodiments of the configurations page driver 102 can be programmed to require the modem's processor 106 to perform diagnostic tests regarding the modem's 100 configuration settings and store those configuration settings in the memory 112. This diagnostic test and storing operation can be performed each time the configuration settings are changed, performed periodically or in accordance to some other schedule, performed on-demand (e.g., when requested by a user), etc. In some embodiments, the configurations page driver 102 can be configured to run from a Unified Extensible Firmware Interface (UEFI) driver 104 of the modem 100. The UEFI driver 104 can be a software module or engine configured to define a software interface between the modem's 100 operating system and its firmware. For instance, embodiments of the UEFI driver 104 can be programmed to run a boot loader operation. When the modem 100 is turned off, the modem's 100 software is typically stored in non-volatile memory 112. When the modem 100 is turned back on (i.e., booted), it does not have immediate access to that software, and so the boot loader executes a program to start a sequence that will pull data and programs from the non-volatile memory. After the boot sequence is completed, the processor 106 of the modem 100 then “kernels” into memory 112 for execution of the operating system. This boot loader can operate in stages, wherein several programs of increasing complexity are loaded. In some embodiments, the UEFI driver 104 and the configurations page driver 102 can work in conjunction to cause the boot loader to pull information from the configuration settings stored in the modem's 100 memory 112 while the modem 100 is booting up.

In an exemplary embodiment, the modem's 100 memory 112 includes a set of default communication protocol settings. These default communication protocol settings are stored in the modem's 100 memory 112, and are used to allow the modem 100 to perform its communication functions. For instance, if the modem 100 is used for Internet communications, the default communication protocol settings will include an Internet protocol suite (e.g., a TCP/IP). These default communication protocol settings can be part of the default configuration settings for the modem 100. As noted herein, a user may desire to modify or tailor the modem's 100 configuration settings. This can involve creating a configuration page, the configuration page being a modified set of configuration settings (e.g., modified from the default settings and/or modified from the previously set configuration settings). A configuration page for an Internet protocol suite can include configuration settings related to communication protocols and security features. Typical communication protocol settings can include any one or combination of: 1) Internet connection type settings; 2) Internet username and password settings; 3) Maximum Transmission Units (MTUs) settings; 4) Network or connection modes (e.g., always on, manually connect, etc.) and operating bans settings; 5) Domain Name System (DNS) server settings; 6) Data Source Name (DSN) settings, 7) dial-up settings; and 8) link monitor settings; 9) establishing a guest network settings. Typical security features can include any one or combination of: 1) firewall settings; 2) security type settings; 3) remote administration settings; 4) Universal Plug and Play (UPnP) settings; 5) Service Set Identifier (SSID) settings; 6) Private Wireless Fidelity (Wi-Fi) Network settings; 7) Media Access Control (MAC) filter settings; 8) Dynamic host Configuration Protocol (DHCP) settings; and 9) parental control settings. The lists of communication protocols and security features settings presented above are exemplary only, and are not intended to limit the systems and methods disclosed herein to these lists.

When a user modifies a configuration setting, a user generates a new configuration page(s) from which the modem's 100 processor 106 pulls information to operate the modem 100 in accordance with the operational parameters set by the configuration page(s). The configurations page driver 102 can be programmed to store the configuration page in the modem's 100 memory 112. As noted above, this saving of the configuration page can be performed each time the configuration settings are changed, periodically or in accordance to some other schedule, performed on-demand (e.g., when requested by a user), etc. The saved configuration page can be referred to herein as the backup configuration page. The backup configuration page can be accessed by the configurations page driver 102 to cause the processor 106 to operate the modem 100 in accordance with the operational parameters set by the backup configuration page. The configurations page driver 102 can access the backup configuration page on-demand or when some other condition is met. For instance, a user can cause the configurations page driver 102 to access the backup configuration page at any time when the modem 100 is in operation, when the modem 100 is powered on, when the modem is booting up (e.g., by virtue of the configurations page driver 102 running from the UEFI driver 104), when the modem 100 is prompted to be rest to its default configuration settings (e.g., if prompted to be reset to its default configuration settings, the configurations page driver 102 can access the backup configuration page and provide a user the option to use the default configuration settings or use the settings associated with the backup configuration page), etc. As will be explained in detail later, a user can do this via a management interface (e.g., a WebGUI, a MobileApp, a Command-Line Interface (CLI), a Simple network Management Protocol (SNMP), a Technical Report-069 (TR069) application protocol TR069), actuation of a button on the modem 100, etc.

In some embodiments, the configurations page driver 102 can be programmed to perform a diagnostic test. The diagnostics test can be performed each time the configuration settings are changed, periodically or in accordance to some other schedule, performed on-demand (e.g., when requested by a user), etc. In some embodiments, the configurations page driver 102 can be programmed to perform the diagnostics test before the configuration page is saved. In some embodiments, the configurations page driver 102 can be programmed to prevent saving the configuration page until the diagnostic test is performed. In some embodiment, the configurations page driver 102 can be programmed to prevent saving the configuration page unless the diagnostic test yields a positive result.

The diagnostic test can be configured to perform analytics on the configuration settings associated with the configuration page to determine how the configuration settings affect the operability of the modem 100. In an exemplary embodiment, the diagnostic test can involve determining whether the voice service (e.g., perform a line card loop diagnostic test), the Data Over Cable Service Interface Specification (DOCSIS) service (e.g., performing a Transmission Control Protocol/User Datagram Protocol (TCP/UDP) speedtest), and/or the Wi-Fi service (e.g., examine the latest one day Wi-Fi event log to determine whether there is a Wi-Fi client connected and that traffic is passing through to the Wide Area Network (WAN) side) is/are operating correctly. This can further involve examining other event logs for voice/DOCSIS/Wi-Fi to determine whether there are other critical error logs that may impact service. If any one or combination of the diagnostic test results is/are negative (e.g., a result that negatively impacts service), then the diagnostic test yields a negative result. If all of the diagnostic test results are positive (e.g., each results in no negative impact on service), then the diagnostic test yields a positive result.

If the configurations page driver 102 is programmed to prevent saving the configuration page unless the diagnostic test yields a positive result, then when the diagnostic test does yield a positive result, the configuration page is then saved as the backup configuration page. When the diagnostic test yields a negative result, the configuration page is not saved as the backup configuration page. In addition, or in the alterative, to not saving the configuration page as the backup configuration page, the configurations page driver 102 can cause the processor 106 to generate a warning signal that informs a user of the configuration settings associated with the configuration page that led to the negative diagnostic test result. The warning signal can appear in the WebGUI. The WebGUI is a user interface that can be accessed by the user's communication device 122 connected to the modem 100. There is no need to have access to Internet to view the WebGUIs because they are stored in the memory 112 of the modem 100. Viewing the WebGUI can be achieved by opening an Internet browser window in the display of the communication device 122 and typing in the Internet Protocol (IP) address (e.g., type in 193.164.1.1) of modem 100 in the address bar of the Internet browser window. This can cause the WebGUIs to appear on the display of the communication device 122. The warning signal can appear when the WebGUI is viewed. The warning signal can include details of the configuration settings that lead to the negative diagnostic test, the details of the diagnostic test, the date and time the negative diagnostic test result was generated, etc.

In some embodiments, the modem 100 includes light indicators 108 that indicate whether certain functions of the modem 100 are being performed and/or provide an activity status of the modem 100. For instance, a surface of the housing 110 can include a plurality of light indicators 108 having light emitting diodes (LEDs) that emit light based on the activity status of the modem 100. The processor 106 can be configured to perform analytics on any of the operating modules and/or receive signals from switches, sensors, etc. that are indicative of activity levels of the operating modules. Each light indicator 108 can be connected to the processor 106 and illuminate based on the activity level(s). The processor 106 can cause the light indicators 108 to illuminate as a function of the activity status. For instance, any one or combination of the light indicators 108 can illuminate, not illuminate, illuminate at a certain color (e.g., red, green, yellow, etc.), illuminate at a constant and continuous emission, illuminate in pulses with a pulse frequency, illuminate in pulses at a pulse duration, illuminate at a certain brightness, illuminate with a changing color, etc. based on the activity level of the modem 100.

These light indicators 108 can include a power indicator light 108 (indicating whether electrical power is being supplied to the modem), an upstream/downstream (US/DS) indicator light 108 (indicating whether an US/DS connection has been made), an online indicator light 108 (indicating that a connection to a webserver has been made), a Telephone line-1 (Tel1) indicator light 108 (indicating the communication status of telephone line 1), a Telephone line-2 (Tel2) indicator light 108 (indicating the communication status of telephone line 2), a Battery indicator light 108 (indicating whether electrical power is being supplied from the battery of the modem 100, a WiFi 2.4G indicator light 108 (indicating whether a WiFi connection over a 2.4 G network has been established), a WiFi 5G indicator light (indicating whether a WiFi connection over a 2.4 G network has been established), etc. Other indicator lights 108 can include a digital subscriber line (DSL) indicator (indicating whether an effective DSL connection has been made), a Personal Computer (PC) card port indicator (indicating whether a PC card is plugging into the PC card port), a Home Phoneline Networking Alliance (HPNA) port indicator light (indicating whether a HPNA link has been made), etc.

In addition, or in the alternative, to generating a warning signal to the WebGUI, the warning signal can be sent to the processor 106 so as to cause the processor to illuminate the indicator lights 108. The illumination sequences and/or schemes of the indicator lights 108 can be indicative of the configuration settings associated with the configuration page that led to the negative diagnostic test result. The illumination sequences and/or schemes can include combinations and/or permutations of light indicators 108 being on or off, the color the light indicators 108 are being illuminated, whether the light indicators 108 are illuminating at a constant emission or with a pulsation, with which the frequency light indicators 108 are pulsing, with which duration the light indicators are pulsing, etc. A user can then monitor the light indicators 108 during operation of the modem 100 to assist with diagnosis.

Monitoring the light indicators 108 can assist a user in determining whether the voice service, the DOCSIS service, and/or the Wi-Fi service is/are operating correctly because, depending on the results of the boot diagnostic test, the processor 106 causes the light indicators 108 to illuminate via a predetermined illumination scheme. It is contemplated for these diagnostic tests to be operated in sequential order; however, the diagnostic tests can be implemented by any other order or sequence. For instance, configurations page driver 102 can be configured to execute the voice service diagnostic test, the DOCSIS service diagnostic test after the voice service diagnostic test, and the Wi-Fi service diagnostic test after the DOCSIS service diagnostic test. In some embodiments, these diagnostic tests can be implemented only after the previous test has been determined to be successful (e.g., if a positive result is obtained). In some embodiments, the subsequent test can be implemented regardless of whether it has been determined that the previous test had been successful.

The light indicator 108 illumination sequences and/or schemes can be indicative of the positive and/or negative result for each diagnostic test.

If the modem 100 experience a service problem, the backup configuration page can be accessed by the configurations page driver 102 to cause the processor 106 to operate the modem 100 in accordance with the operational parameters set by the backup configuration page. The backup configuration page will include the configuration settings associated with the last configuration page that resulted in a positive diagnostic test. In addition, the warning signal (in the WebGUI and/or via the illumination sequences and/or schemes of the indicator lights 108) can assist the user in determining which configuration settings (if any at all) led to the service problem. Accessing the backup configuration page and/or viewing the details of the warning signal can be achieved via a management interface (e.g., aWebGUI, a MobileApp, a Command-Line Interface (CLI), a Simple network Management Protocol (SNMP), a Technical Report-069 (TR069) application protocol TR069), actuation of a button on the modem 100, etc.

It is understood that other factors can lead to a service problem (other than configuration settings), and that the systems and methods disclosed herein may not be used to detect them. However, the disclosed systems and methods can be used to detect if a configuration setting did lead to a service problem. In addition, regardless of whether the configuration setting led to the service problem, a user can access the backup configuration page that includes the user's desired configuration settings and for which are known to generate a positive diagnostic test result.

The modem 100 architectures and operations described above are exemplary only. It is understood that other modem 100 architectures and operational constraints can be used. It is further understood that any of the modems 100 can include other circuitry and operating modules, such as data compressors, buffers, scramblers, clocks, filters, analog to digital converters, signal processors, etc. to improve or tailor the functionality of the modem 100 and/or facilitate meeting a desired design objective for the modem 100.

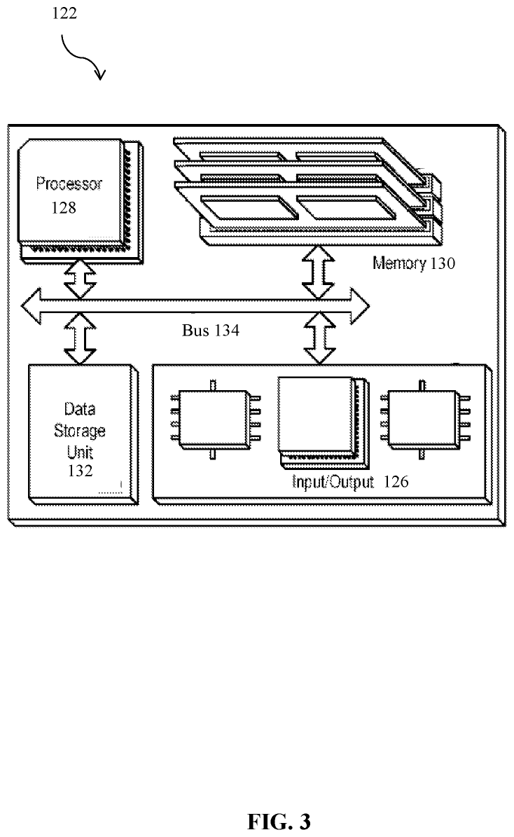

Referring to FIG. 3, embodiments of the modem 100 disclosed can function as a gateway so as to provide a network node equipped to interface a first communication device 122 operating on a first communication protocol with a second communication device 122 operating on a second communication protocol. FIG. 3 shows an exemplary architecture for any one or combination of the first communication device 122 and second communication device 122. The first and/or second communication device 122 can be a computer, a broadband device, a multimedia device, etc. The communication device 122 can include an input/output device 126 configured to provide input/output operations for the communication device 122. In some embodiments, the input/output device 126 can include driver devices configured to receive input data and send output data to the modem 100, as well as send communications to, and receive communications from, various networks.

The communication device 122 can include a processor 128, a memory 130, a storage device 132, and the input/output device 126. Each of the components 128, 130, 132, and 126 can, for example, be interconnected using a system bus 134. The processor 128 is capable of processing instructions for execution within the communication device 122. The processor 128 can be a single-threaded processor or a multi-threaded processor. The processor 128 is capable of processing instructions stored in the memory 130 or on the storage device 132. The memory 130 stores information within the communication device 122. The memory 130 can be a computer-readable medium, a volatile memory unit, a non-volatile memory unit, etc. The storage device 132 is capable of providing mass storage for the communication device 122. The storage device 132 can be a computer-readable medium, a hard disk device, an optical disk device, flash memory, or some other large capacity storage device.

The communication device 122, and components thereof, can be realized by instructions that, upon execution, cause one or more processing devices to carry out the processes and functions embedded in software stored within the memory 130 or storage device 132. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, e.g., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question (e.g., code that constitutes processor firmware, a protocol stack, a database management system, an operating system, or a combination of one or more of them).

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer (or processor) or on multiple computers (or multiple processors) that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors (general microprocessors being transformed into special purpose microprocessor through the application of algorithms described herein), and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device (e.g., a mobile communications device, a phone, a cable modem, a set-top box, a mobile audio or video player, or a game console, to name just a few).

Computer readable media suitable for storing computer program instructions and data include all forms of non volatile memory, media and memory devices, including by way of example semiconductor memory devices, e.g., Erasable Programmable Read-Only Memory (EPROM), Electrically Erasable Programmable Read-Only Memory (EEPROM), and flash memory devices; magnetic disks, e.g., internal hard disks or removable disks; magneto optical disks; and Compact Disc Read only Memory (CD ROM) and Digital Versatile Disc Read Only Memory (DVD ROM) disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device (e.g., a mouse or a trackball, by which the user can provide input to the computer). Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

While this specification contains many specific implementation details, these should not be construed as limitations on the scope of any invention or of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing can be advantageous.

What is claimed is:

1. A modem, comprising:
a processor including a configurations page driver; and
a memory operatively associated with the processor; and
wherein the configurations page driver is configured to store configuration settings of the modem as a backup configuration page in the memory.

2. The modem of claim 1, wherein:
the configuration page driver is configured to access the configuration settings of the backup configuration page and cause the processor to operate the modem in accordance with an operating parameter set by the configuration settings.

3. The modem of claim 1, wherein:
the memory includes default configuration settings;
the configuration settings of the backup configuration page include modifications made to the default configuration settings.

4. The modem of claim 1, further comprising:
a Unified Extensible Firmware Interface (UEFI) driver, the UEFI driver configured to provide a software interface between an operating system for the modem and firmware for the modem; and
wherein the configuration page driver is configured to run from the UEFI driver.

5. The modem of claim 1, wherein:
the configuration page driver is configured to perform a diagnostic test.

6. The modem of claim 5, wherein:
the diagnostic test includes a voice service diagnostic test, a Data Over Cable Service Interface Specification (DOCSIS) service test, and/or a Wireless Fidelity (Wi-Fi) service test.

7. The modem of claim 5, wherein:
the diagnostic test is configured to generate a negative result if the diagnostic test indicates a service problem with the modem; and
the diagnostic test is configured to generate a positive result if the diagnostic test indicates no service problem with the modem.

8. The modem of claim 5, wherein:
the configurations page driver is configured to store configuration settings of the modem as the backup configuration page in the memory after the diagnostic test is performed.

9. The modem of claim 7, wherein:
the configurations page driver is configured to store the configuration settings of the modem as the backup configuration page in the memory when the diagnostic test generates the positive result.

10. The modem of claim 7, wherein:
the configurations page driver is configured to prevent storage of the configuration settings of the modem as the backup configuration page in the memory when the diagnostic test generates the negative result.

11. The modem of claim 7, wherein:
the configurations page driver is configured to cause the processor to generate a warning signal when the diagnostic test generates the negative result.

12. The modem of claim 11, wherein at least one of:
the warning signal is displayed as part of a Web Graphical User Interface (WebGUI); and
the warning signal is transmitted to the processor to cause the processor to illuminate at least one light indicator of the modem in an illumination sequence and/or illumination scheme.

13. The modem of claim 5, wherein:
the diagnostic test involves analytics to determine whether the configuration settings lead to a service problem for the modem; and
the configurations page driver is configured to cause the processor to generate a warning signal when the diagnostic test determines that the configuration settings lead to the service problem.

14. The modem of claim 13, wherein:
the warning signal includes information about the configuration settings that led to the service problem.

15. The modem of claim 13, wherein at least one of:
the warning signal is displayed as part of a Web Graphical User Interface (WebGUI); and
the warning signal is transmitted to the processor to cause the processor to illuminate at least one light indicator of the modem in an illumination sequence and/or illumination scheme.

16. A communication system, comprising:
a first communication device in connection with a first modem; and
a second communication device in connection with a second modem;
wherein the first modem comprises:
a first processor including a first configurations page driver; and
a first memory operatively associated with the first processor; and
wherein the first configurations page driver is configured to store configuration settings of the first modem as a first backup configuration page in the first memory.

17. The communication system of claim 16, wherein the second modem comprises:
a second processor including a second configurations page driver; and
a second memory operatively associated with the second processor; and
wherein the second configurations page driver is configured to store configuration settings of the second modem as a second backup configuration page in the second memory.

18. A method for creating a backup configuration page for a modem, the method comprising:
storing configuration settings of a modem as a backup configuration page in a memory of the modem, the configuration settings being different from default configuration settings for the modem.

19. The method of claim 18, further comprising:
accessing the configuration settings of the backup configuration page to set an operating parameter of the modem.

20. The method of claim 18, wherein:
storing the configuration settings involves generating the backup configuration page each time the configuration settings are modified, generating the backup configuration page periodically, and/or generating the backup configuration page on-demand.
